(19) United States
(12) Patent Application Publication
(10) Pub. No.: US 2007/0138109 A1
(43) Pub. Date: Jun. 21, 2007

(54) Oxidizing composition for salt water

(76) Inventors: Thomas Peter Tufano, Wilmington, DE (US); Edward Blake Lightcap, Landenberg, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/316,655

(22) Filed: Dec. 21, 2005

(51) Int. Cl. C02F 1/32

(52) U.S. Cl. 210/748

(57) ABSTRACT

An improved method of treating a body of salt water containing chloride ion in which the level of chlorine in the water is controlled by an electrochemical chlorine generator wherein the improvement comprises increasing the chlorine generation in the water without increasing the generator output by addition of a composition comprising potassium monopersulfate is disclosed.

### FIELD OF THE INVENTION

This invention relates to the field of water treatment methods employing electrochemical chlorine generators to maintain the cleanliness and comfort of salt water recirculating systems such as in swimming pools, hot tubs and spas.

### BACKGROUND OF THE INVENTION

Swimming pools, hot tubs and spas are an increasingly popular form of recreation and exercise, both at home and at commercial or public facilities. Many pools, hot tubs and spas are characterized as “fresh water” systems, wherein the halide (predominately chloride) content of the water is typically relatively low (e.g., less than about 500 mg/kg or parts per million, ppm). Increasingly, however, so-called “salt water” systems are growing in popularity and prevalence due to their offer of improved skin comfort, greater buoyancy, and perceived ease of maintenance. In salt water systems, the salt level is generally maintained at about 2000-4000 mg/kg by the addition of sodium chloride. Seawater pools, having dissolved salt levels (principally sodium chloride) of about 35,000 mg/kg also exist, typically in coastal locations.

Maintaining the cleanliness and comfort of all forms of recreational water is often challenging because of widely varying swimmer or bather loads, swimming and bathing activities, facility design, hours of operation, play features, weather, and other conditions. Fresh water pools require frequent monitoring and the regular addition of water treatment chemicals, including sanitizers, oxidizers, and products to maintain water balance.

The reaction of monopersulfate and halides to form an active halogen is known. For example, D. H. Fortnum, et al. (J. Am. Chem. Soc. (1960) Vol.82, 778-82) investigated the kinetics and mechanism of oxidation of halide ions by monosubstituted peroxides. The rate of oxidation by monopersulfate decreases dramatically with the type of halide ion being oxidized, thus the rate for iodide ion is much faster than for bromide ion and the rate for bromide ion is much faster than for chloride ion. The oxidation follows simple second-order kinetics overall, first-order in each of monopersulfate and halide ion, respectively, i.e., rate=k[HSO₅⁻][X⁻].

In fresh-water swimming pool systems using an active chlorine source as the primary sanitizer, the rate of oxidation of chloride to chlorine by use of an oxidizer such as a persulfate salt is too slow to be effective. This is because the bimolecular rate constant for the oxidation is small compared to that of bromide to bromine and the concentration of chloride ion is low (less than about 500 mg/kg).

Choudhury et al, in U.S. Pat. No. 6,110,387, disclose a process for sanitizing a body of water by introducing a sufficient amount of a sulfamate source to provide a concentration of 0.25 to 2 mmol/L, and a soluble bromide salt to provide a concentration of 0.34 to 6.8 mmol/L. Periodically sufficient oxidant is added to maintain an available bromine concentration of 2 to 6 mg/kg in the water. Choudhury et al. did not disclose any process for use in a salt-water pool using chlorine for sanitizing.

Compared to fresh water systems, salt water swimming pools, hot tubs and spas offer a unique set of challenges due to the much higher level of salt. Sanitization in such salt-water facilities is typically provided by installation of an electrochemical cell, called a chlorine generator, to generate active chlorine. However, the chlorine level must be carefully controlled, balancing a number of factors. Too high a chlorine level can cause discomfort to swimmers or bathers due to stinging eyes; too low a level can mean inadequate protection against microbial pathogens. During periods of high use, the electrochemical chlorine generator may be inadequate to respond quickly enough to maintain recommended levels of chlorine sanitizer, resulting in insufficient sanitizer residuals. Correcting this deficiency may require replacement with a larger, more expensive generator, or the installation of an additional electrolytic cell. During periods of low demand, such as overnight, chlorine levels may exceed maximum recommended levels for those less-sophisticated systems that do not provide automatic production control of chlorine in response to chlorine residual levels. Furthermore, during electrical shutdowns, the chlorine level can deteriorate to inadequate levels. Relying solely on an electrochemical chlorine generator for sanitization in a salt water system has the additional disadvantage that the biocidal efficacy of the chlorine sanitizer can be compromised by reaction with non-microbial contaminants to form so-called combined chlorine compounds. In addition, excessive levels of chlorine may even react with some contaminants to form malodorous and potentially harmful disinfection byproducts such as nitrogen trichloride and chloroform.

There is a need for an improved method of maintaining the cleanliness and comfort of salt-water swimming pools and spas. The present invention provides a process for independently elevating chlorine production in salt water recirculating systems, as needed, without the addition of chlorine-containing chemicals.

### SUMMARY OF THE INVENTION

The present invention comprises an improved method of treating a body of salt water containing chloride ion in which the level of chlorine in the water is controlled by an electrochemical chlorine generator wherein the improvement comprises increasing the chlorine generation in the water without increasing the generator output by addition of a composition comprising potassium monopersulfate.

The present invention further comprises a composition comprising:

a. from about 50% to about 99.9% by weight potassium monopersulfate

b. from about 0.1% to about 50% halogen stabilizer

c. from about 0% to about 40% of a buffering agent, and

d. 0% to about 20% of a clarifier provided that the total of components a through d add up to 100% by weight.

### DETAILED DESCRIPTION OF THE INVENTION

Herein trade names are shown in upper case.

This invention comprises an improved method of sanitizing salt water systems such as salt water swimming pools, hot tubs and spas, containing chloride salt concentrations (typically sodium chloride) of about 1000 to about 35000 mg/kg, wherein the level of chlorine in the water is controlled by an electrochemical chlorine generator. In this improved method, a measured amount of a composition comprising potassium monopersulfate is added to the water to increase the chlorine level by oxidizing chloride ion to chlorine without the need to increase the generator output. The composition comprising potassium monopersulfate may be added as a single large dose to elevate rapidly the chlorine residual sanitizer levels, or may be added gradually (for example, as an aqueous solution) to more continuously and slowly increase chlorine levels. Both methods have the added advantage that the potassium monopersulfate also provides peroxygen oxidation of non-microbial contaminants that may be present in the water. Below salt concentration of about 1000 mg/kg. the rate of generation of chlorine progressively becomes impracticably slow. Typical salt-water pools contain chloride salts at a concentration range of about 2000 to about 4000 mg/kg, expressed as sodium chloride.

The halide ion dissolved in the salt water will predominately be chloride ion, with the result that an active form of chlorine (HOCl or OCl⁻ depending upon pH) will be formed by oxidation. It is understood, however, that other halide ions such as bromide and iodide may be present in lower concentration. Therefore active forms of bromine or iodine may also be formed by oxidation which may also contribute to the overall sanitizing effect.

Preferred for use in the method of the present invention as an oxidant is potassium monopersulfate, in particular, OXONE, a crystalline triple salt of enhanced solid state stability having the formula 2KHSO₅.KHSO₄.K2SO₄ (available from E. I. du Pont de Nemours and Company, Wilmington Del.). OXONE has a theoretical active oxygen content of 5.2%; commercial preparations thereof typically having an active oxygen content of about 4.7%.

The oxidant, as well as the compositions used in the present invention described below are preferably in the form of a solid granular mixture. However, pre-measured unit doses in the form of tablets or sachets are also suitable. In particular, unit doses of granular product can be conveniently packaged in water-soluble film, such as polyvinyl alcohol. Alternatively, the composition can be prepared as a solution and automatically delivered to the water to be treated.

The present invention further comprises a composition comprising by weight:
about 50% to about 99.9% potassium monopersulfate,
about 0.1% to about 50% of a halogen stabilizer,
0 to about 40% of a pH buffering agent, and
0 to about 20% of a clarifier,

provided that the total of the above components adds up to 100% by weight.

This composition is useful in the method of the present invention described above. The composition is added to the salt water to be treated as described for the potassium monopersulfate.

The potassium monopersulfate used in the composition is preferably the OXONE triple salt as described above. The halogen stabilizer is included to stabilize free chlorine as it is formed against UV degradation. Suitable halogen stabilizers include cyanuric acid, sulfamic acid or 5,5-dialkylhydantoin. Cyanuric acid is preferred. Since potassium monopersulfate triple salt is acidic, optionally blending with a pH-buffering agent is useful to maintain the pH neutrality and alkalinity of treated water. Suitable buffering agents include alkali metal carbonates, alkali metal bicarbonates, alkali earth metal carbonates, and alkali earth metal bicarbonates. Preferred is anhydrous sodium carbonate. A clarifier may also optionally be present such as a synthetic cationic polymer, chitin, chitosan, and aluminum salts such as sulfates. Preferred is the synthetic cationic polymer.

The composition is prepared by physically mixing the components. Any dry blending operation is suitable as known by those skilled in the art. The oxidant alone or the dry blend can be directly added to the water to be treated, or the dry blend is dissolved in water for addition or metering over time into the water to be treated.

The composition of the present invention is optionally blended with other useful water treatment chemicals. Other optional additives useful for treating recreational water may include algae control agents (such as cupric salts and polymeric quaternary ammonium chloride products); boron source compounds (such as boric acid); corrosion inhibitors; chloride salts (such as alkali metal chlorides), diluents (such as sodium sulfate); anti-caking agents (such as magnesium carbonate); stain and scale control agents (such as chelating agents and sequestering agents including ethylenediaminetetraacetic acid, disodium salt); electrolytic cell cleaning agents; tableting aids (such as lubricants and binders); enzymes; lanthanum salts (such as halides, oxycarbonates, and carboxylates); and fragrances and colorants. The types of optional additives are given above as examples and are not intended to be all-inclusive.

The composition is added to the salt water system by any of a number of ways. For example, in a residential swimming pool it is most readily added in discrete amounts periodically on a regular or irregular basis over time by broadcasting a granular solid mixture or by the addition of water-soluble pouches or tablets. In a commercial pool, it may be added as part of a liquid feed system. Any convenient method may be used for adding the composition; the method of addition is not intended to be a limiting feature of this invention.

The above composition can be added on a regular basis, periodically or by continuously metering the composition into the salt water, depending on demand, primarily based on the number of users. Typically, the composition may be added once or twice a week, and more frequently during periods of hot weather and high bather use. The dosage should be sufficient to achieve and maintain a desired chlorine level before the next period of high demand. Chlorine levels above about 5 mg/kg in water should generally be avoided to avoid bather discomfort. Because of the large number of factors affecting demand and timing, it is suggested that initial dosages should be low, gradually increasing with frequent monitoring and experience. It is suggested that the initial dosage of the composition per addition correspond to a concentration of about 1 to about 100 mg/kg, preferably about 6 to about 80 mg/kg and more preferably about 12 to about 60 mg/kg. The lower end of the concentration range (such as about 6 to about 24 mg/kg) is typically well suited for the treatment of swimming pools, while the upper end of the range (such as about 24 to about 60 mg/kg) is useful for hot tubs and spas. Preferably, bathers should not remain in the pool or spa during the addition of the potassium monopersulfate, but may re-enter after a short interval (about 15 to 30 minutes).

In residential systems, there is often no feedback system to automatically shut down the chlorine generator in response to excessive chlorine concentration in the water. Such residential systems are typically a part of a filter operation, arranged such that, when the filter is cycled on, so is the chlorine generator. The residential end-user does have the ability to set the amperage to the system. Commercial test kits easily measure chlorine, so the user determines appropriate amperage to give the desired level of chlorine. If the salt water is periodically oxidized with potassium monopersulfate, lower amperage can be maintained. In larger commercial pools, typically a feedback control system would monitor chlorine levels and automatically cycle the chlorine generator on and off. A potassium monopersulfate treatment in all cases has the potential for electrical power savings. Use of lower amperage over time leads to longer electrode lifetime, a considerable savings since electrodes can be expensive to replace.

As described by Coffey in U.S. Pat. No. 6,761,827, herein incorporated by reference, the electrodes used in the electrolytic cell may be of any suitable material. However, the electrodes are generally not sacrificial electrodes made of copper, silver, zinc, or any alloy thereof. One suitable electrode material is titanium, which can be coated to reduce corrosion and fouling, e.g. with a precious or semi-precious metal, such as platinum, ruthenium, or iridium.

The surface area of electrodes used in the invention can be reduced as compared to the surface area of electrodes used in simple electrolytic purification (i.e., without the periodic use of a potassium monopersulfate oxidative treatment). The amount of this reduction may vary greatly depending upon a number of factors: pool size, frequency and dosage of the monopersulfate treatment, type of electrode, degree of salinity. Thus the use of monopersulfate can offset inadequacies of an undersized electrolytic chlorine generator.

According to Coffey, assuming a halide ion concentration ranging from about 2000 mg/kg to about 4000 mg/kg, which is a typical range for salinated pool water, and a DC voltage power supply of about 5 to about 25 V, electrode surface areas generally vary between about 10 cm² to about 150 cm² and will produce a chlorine concentration (calculated as Cl₂) of between about 0.5 mg/kg and about 2.0 mg/kg.

The following table illustrates the kinetics of oxidation of chloride ion vs. time and OXONE concentration. Under typical pool water conditions of pH, alkalinity and hardness, and at constant sodium chloride concentration, the rate of free chlorine formation is directly proportional to the applied OXONE concentration.

TABLE 1
Free chlorine generation versus time and OXONE concentration.^{(a)}

| | OXONE Concentration, mg/kg | | | | | |
|---|---|---|---|---|---|---|
| | 6 | 12 | 24 | 48 | 72 | 96 |
| Time, h | Free Chlorine Concentration, mg/kg | | | | | |
| 0 | 0.0 | 0.0 | 0.0 | 0.0 | 0.0 | 0.0 |
| 0.5 | 0.06 | 0.08 | 0.46 | 1.51 | 1.4 | 2.4 |
| 1 | 0.18 | 0.4 | 0.94 | 2.31 | 2.8 | 3.6 |
| 1.5 | — | — | — | — | 3.8 | 5.2 |
| 2 | 0.43 | 0.86 | 1.73 | 3.93 | 4.9 | 6.5 |
| 2.5 | — | — | — | — | 5.8 | 8.0 |
| 3 | — | — | 2.33 | 4.99 | 6.5 | 8.7 |
| 3.3 | 0.61 | 1.38 | — | — | — | — |
| 3.8 | — | — | — | 5.44 | — | — |
| 4 | — | — | — | — | 8.4 | 10.9 |
| 4.2 | 0.75 | 1.57 | — | — | — | — |
| 4.25 | — | — | 2.88 | — | — | — |
| 5 | — | — | — | — | 9.4 | 12.6 |
| 6 | 0.9 | 1.85 | 3.46 | 7.58 | 9.7 | 13.7 |
| 8 | — | — | 3.83 | 8.16 | 11.6 | 15.4 |
| 8.3 | 0.98 | 2.05 | — | — | — | — |
| % | 80 | 84 | 76 | 82 | 77 | 77 |
| Theoretical | | | | | | |

^{(a)}Water Conditions: NaCl, 3000 mg/kg; temperature 84° F. (29° C.); total alkalinity, 100-120 mg/kg; total hardness 240-260 mg/kg; and pH 7.4-7.6.

The second order polynomial equation derived from the above data in Table 1 at 29° C. is:
Free chlorine concentration (mg/kg)=(0.040t−0.0024t²)×C₀

where C₀=initial OXONE concentration in mg/kg (for C₀=6 to 96 mg/kg) and t is time (h).

The use of this invention in the treatment of salt-water recreational water provides several advantages. The treatment provides non-chlorine oxidation of non-microbial contaminants (organic load) without the potential of forming mal-odorous and potentially hazardous chlorinated disinfection byproducts associated with the practice of applying high chlorine doses. The treatment provides an independent chemical way to elevate residual chlorine sanitizer levels without increasing the output of the electrochemical chlorine generator or adding an active chlorine sanitizing compound. It also provides a way to increase chlorine rapidly during periods of high bather load. The treatment provides an oxidizing shock treatment with a short re-entry time (“shock and swim”). The treatment provides a composition which can be formulated for greater functionality (free chlorine stabilization, pH buffering, algaecidal activity, clarification, etc.). It also provides power savings and extension of electrode lifetime.

### Materials and Test Methods

OXONE monopersulfate compound is available from E.I. du Pont de Nemours and Company, Wilmington Del.

FRESH 'N CLEAR chlorine-free oxidizer is available from Leslie's Poolmart (Phoenix Ariz.).

Reagent grades of cyanuric acid, sodium carbonate, sodium bicarbonate, calcium chloride dihydrate, sodium bisulfate, and sodium sulfite are available from Sigma-Aldrich Chemical Co. (Milwaukee Wis.).

Test Method 1

Free and total available chlorine concentrations were determined titrimetrically using Method #4500-Cl F, N,N-diethyl-p-phenylenediamine-ferrous ammonium sulfate titrimetric analysis, as described in “Standard Methods for the Examination of Water and Wastewater”, 19^{th} edition, American Public Health Association, Washington D.C., 1995.

Test Method 2

For solutions containing active chlorine and residual OXONE, total chlorine and residual OXONE concentrations were determined by a modification of Method 4500-Cl F, as described in Kroll, U.S. Pat. No. 6,180,412, by adding a solution of EDTA (ethylenediaminetetraacetic acid, disodium salt) to react with OXONE. The active chlorine is measured by titration, once with EDTA present, and once without it. The measurement without EDTA represents the sum of active chlorine plus residual OXONE. Thus, the difference between the two measurements represents the OXONE concentration in solution.

Test Method 3

Total calcium hardness, total alkalinity and pH were measured using a Lamotte Pro 250 Plus test kit manufactured by Lamotte Company (Chestertown Md.).

### EXAMPLES

The materials and Test Methods listed above were used in the following Examples.

### Example 1

A 300-gallon (1135 L) residential spa was filled with local source water, heated to 37-38° C., and dosed with 3000 mg/L sodium chloride. The water was further chemically conditioned prior to the start of the experiment as follows: total calcium hardness was adjusted to 180 mg/L calcium carbonate using calcium chloride dihydrate; total alkalinity to 90 mg/L calcium carbonate using sodium bicarbonate; and the pH to 8.1-8.2 with sodium bisulfate. The electrolytic chlorine generator was submerged in the spa water and turned on at its maximum output setting. To facilitate good mixing, the water was continuously circulated throughout the course of the experiment. Total available chlorine and residual OXONE measurements were made by N,N-diethyl-p-phenylenediamine titration (Test Method 2). The starting point for the experiment was marked when the total chlorine reached approx. 0.5 mg/L [time (t)=0].

At time=0.5 h, 27.2 grams (24 mg/L) of FRESH 'N CLEAR chlorine-free oxidizer (containing 85% OXONE) was broadcast into the spa water (corresponding to 20.4 mg/L OXONE applied). Total available chlorine and residual OXONE concentration measurements were made at regular time intervals (Test Method 2). The data are given in Table 2 below. It can be seen that the addition of a single dose of a composition containing OXONE potassium monopersulfate rapidly increased the rate of chlorine generation. Specifically, two hours after OXONE addition, the increase in total chlorine is approximately 3.45 mg/L; whereas in Comparative Example A (below), the increase in total chlorine is only 0.57 mg/L after two hours of operation.

### Example 2

A 300-gallon (1135 L) spa was filled with source water, brought to temperature and chemically conditioned as described in Example 1. The pH of the spa water measured 7.4-7.5. The electrolytic chlorine generator was submerged in the spa water and turned on at its maximum output setting. When total chlorine reached approximately 0.4-0.5 mg/L, the experiment was initiated (time=0). At time=1.0 h, 49.9 grams (44 mg/L) of a blend of 75% OXONE and 25% cyanuric acid was broadcast into the spa water (corresponding to 33.0 mg/L OXONE applied). Total available chlorine and residual OXONE concentration measurements were made at regular time intervals using Test Method 2. The data are given in Table 2 below. The data show that the addition of a single dose of a composition of the present invention rapidly increased the total available chlorine concentration within one-half hour after application, from 0.71 mg/L to 2.48 mg/L. In the same length of time, the increase in total available chlorine from the electrolytic chlorine generator alone was only 0.14 mg/L on average (see Comparative Example A). The industry-recommended safe level of free chlorine residual in swimming pools and spas is 1-4 mg/L.

### Comparative Example A

This example demonstrated the rate of active chlorine generation using a “TUBBY” spa water purification system (from Lectranator Systems, Inc., Calgary, Alberta, Canada) in a typical salt water spa. A 300-gallon (1135 L) spa was filled with source water, brought to temperature and chemically conditioned as described in Example 1. The electrolytic chlorine generator was submerged in the spa water and turned on at its maximum output setting. When the total chlorine concentration reached approximately 0.5 mg/L, the experiment was initiated (t=0).

Total chlorine measurements were made at regular time intervals using Test Method 1 for a total of six hours to characterize the chlorine output of the generator, without the addition of an OXONE-containing composition to the spa water. These data are shown below in Table 2. It can be seen that the chlorine output of the generator was very linear with time with an average total chlorine output of 0.28 mg/L/hr.

TABLE 2

| | | |
|---|---|---|
| Example 1 | Example 2 | Comparative |

| | | Residual | | Residual | Example A |
|---|---|---|---|---|---|
| Time | Total Available | OXONE | Total Available | OXONE | Total Available |
| t (h) | Chlorine (mg/L) | (mg/L) | Chlorine (mg/L) | (mg/L) | Chlorine (mg/L) |
| 0* | 0.48 | 0 | 0.44 | 0 | 0.51 |
| 0.5 | 0.60 | 20.4 | 0.58 | 0 | — |
| 1 | 1.71 | 16.9 | 0.71 | 33 | 0.82 |
| 1.5 | 2.72 | 13.5 | 2.48 | 25.8 | — |
| 2 | 3.42 | 9.9 | 3.88 | 19.9 | 1.08 |
| 2.5 | 4.05 | 7.2 | 5.10 | 14.6 | — |
| 3 | 4.55 | 5.3 | 6.07 | 10.8 | 1.35 |
| 4 | 5.12 | 3.1 | 7.63 | 4.6 | 1.61 |
| 5 | 5.78 | 1.1 | 8.34 | 2.3 | 1.97 |
| 6 | — | — | 8.66 | 1.4 | 2.19 |

*t = 0 shows the chlorine level provided by the electrolytic chlorine generator immediately prior to the addition of the OXONE for Example 1 and 2.
*Initial OXONE concentrations were calculated.

The data in Table 2 follows the same polynomial fit as shown above in Table 1, except that data in Table 2 are (a) at a higher temperature and (b) the chlorine generator is contributing linearly to the total chlorine output. The data in Table 2 shows an increase in the rate of chlorine generation was achieved when OXONE, and OXONE plus cyanuric acid, were added, compared to the linear rate of chlorine production of the generator alone.

### Example 3

A 300-gallon (1135 L) spa was filled, brought to temperature, and chemically conditioned as described in Example 1. The pH of the spa water measured 7.8. The electrolytic chlorine generator was submerged in the spa water and turned on at its maximum output setting. When the total chlorine concentration reached approximately 0.7-0.8 mg/L, the experiment was begun (time =0 h). At t=0.5 h, 20% aqueous OXONE solution (130.5 g, corresponding to 23.0 mg/L OXONE applied) was added to the spa water over a period of 12 using a peristaltic pump (Step 1 in Table 3 below). Total available chlorine and residual OXONE concentration measurements were made at regular time intervals, as described in Example 1. The data are shown in Table 3 below. At t=1.5 h, total chlorine increased to 2.87 mg/L. At this point, 9.6 grams of sodium sulfite was added to the spa water to simulate chlorine and oxidizer demand (Step 2). The total chlorine concentration was reduced to 0.14 mg/L and the residual OXONE concentration was reduced to 4.6 mg/L. This cycle was repeated (Steps 3-5) as shown in Table 3. It was observed that in response to simulated, periodic chlorine and oxidizer demand sequences (as would occur with bather use), the total chlorine residual can be rapidly increased within one-half hour to industry-recommended levels in excess of 1.0 mg/L via a liquid OXONE solution feed.

### Comparative Example B

A 300-gallon (1135 L) spa was filled, brought to temperature, chemically conditioned, and set up with the electrolytic chlorine generator as described in Example 3. When the total chlorine concentration reached approximately 0.7-0.8 mg/L, the experiment was begun (t=0). Total available chlorine was produced solely from the output of the chlorine generator, no OXONE solution was added in Steps 1, 3, and 5 of Example 3. Periodically, as shown in Table 3, sodium sulfite was added as in Example 3 (Steps 2 and 4) to simulate chlorine demand. It was observed that the rebound in total available chlorine concentration was relatively slow. Specifically, after each addition of sodium sulfite, the chlorine concentration did not rebound to a minimum recommended level of 1.0 mg/L even after two hours of operation.

TABLE 3

| | Example 3 | | |
|---|---|---|---|
| Time | Total Available | Residual OXONE | Comparative Example B |
| t (h) | Chlorine (mg/L) | (mg/L) | Total Available Chlorine (mg/L) |
| 0 | 0.74 | 0 | 0.75 |
| 0.5 | 0.89 | 0 | 0.91 |
| Step 1 | 20% OXONE solution (130.5 g, 23 mg/L) | | Control, |
| | pumped in over a 12 min. period | | no OXONE solution added |
| 0.7 | — | 23.0 | |
| 1 | 2.05 | 17.9 | 1.04 |
| 1.5 | 2.87 | 14.5 | 1.20 |
| Step 2 | Sodium sulfite (9.6 g) added to simulate | | Sodium sulfite (2.0 g) added to |
| | chlorine and oxidizer demand | | simulate chlorine demand |
| 0 | 0.14 | 4.6 | 0.23 |
| Step 3 | 20% OXONE solution (130.5 g, 23 mg/L) | | Control, |
| | pumped in over a 12 min. period | | no OXONE solution added |
| 0.2 | — | 27.6 | — |
| 0.5 | 1.41 | 22.1 | 0.38 |
| 1.0 | 2.36 | 18.1 | 0.52 |
| 2.0 | 4.0 | 11.7 | 0.81 |
| Step 4 | Sodium sulfite (10.2 g) added to simulate | | Sodium sulfite (1.3 g) added to |
| | chlorine and oxidizer demand | | simulate chlorine demand |
| 0 | 0.2 | 5.5 | 0.16 |
| Step 5 | 20% OXONE solution (130.5 g, 23 mg/L) | | Control, no OXONE solution added |
| | pumped in over a 12 min. period | | |
| 0.2 | — | 28.5 | — |
| 0.5 | 1.5 | 22.8 | 0.3 |
| 1.0 | 2.48 | 18.6 | 0.43 |
| 2.0 | 4.17 | 12.0 | 0.71 |

Initial OXONE concentrations were calculated.

This example demonstrated how the chlorine rebound in response to periodic simulated chlorine demand was relatively slow when relying solely on the output of an electrolytic chlorine generator as shown by Comparative Example B, but was fast when OXONE was added as shown by Example 3.

What is claimed is:

1. An improved method of treating a body of salt water containing chloride ion in which the level of chlorine in the water is controlled by an electrochemical chlorine generator wherein the improvement comprises increasing the chlorine generation in the water without increasing the generator output by addition of a composition comprising potassium monopersulfate.

2. The method of claim 1 wherein the addition is a continuous metering of the composition into the salt water.

3. The method of claim 1 wherein the addition is of discrete amounts of the composition periodically on a regular or irregular basis over time.

4. The method of claim 1 wherein the composition further comprises at least one additional component selected from the group consisting of halogen stabilizer, pH-buffering agent, algae control agent, clarifier, boron source compound, corrosion inhibitor, chloride salt, diluent, anticaking agent, stain and scale control agent, electrolytic cell cleaning agent, tableting aid, enzyme, lanthanum salt, fragrance, and colorant.

5. The method of claim 4 wherein the additional component comprises at least one of a halogen stabilizer, pH-buffering agent, or clarifier.

6. The method of claim 1 wherein from about 1 to about 100 mg/kg of the composition is added to the salt water.

7. The method of claim 6 wherein from about 6 to about 80 mg/kg of the composition is added to the salt water.

8. The method of claim 1 wherein the composition comprises
a. from about 50% to about 99.9% by weight potassium monopersulfate,
b. from about 0.1% to about 50% halogen stabilizer,
c. from about 0% to about 40% of a buffering agent, and
d. 0% to about 20% of a clarifier,
provided that the total of components a through d add up to 100% by weight.

9. A body of salt water treated in accordance with the method of claim 1.

10. A composition comprising:
a. from about 50% to about 99.9% by weight potassium monopersulfate
b. from about 0.1% to about 50% halogen stabilizer
c. from about 0% to about 40% of a buffering agent, and
d. 0% to about 20% of a clarifier
provided that the total of components a through d add up to 100% by weight.

11. The composition of claim 10 wherein the halogen stabilizer is cyanuric acid, sulfamic acid or 5,5-dialkylhydantoin.

12. The composition of claim 10 wherein the carbonate or bicarbonate is an alkali metal carbonate, alkali metal bicarbonate, alkali earth metal carbonate, or alkali earth metal bicarbonate.

13. The composition of claim 10 wherein the clarifier is a cationic polymer, chitin, chitosan, or aluminum salt.

14. The composition of claim 10 further comprising at least one additional component selected from the group consisting of algae control agent, boron source compound, corrosion inhibitor, chloride salt, diluent, anticaking agent, stain and scale control agent, electrolytic cell cleaning agent, tableting aid, enzyme, lanthanum salt, fragrance, and colorant, provided that the total of components add up to 100% by weight.

15. The composition of claim 10 which generates chlorine upon addition to a body of salt water containing chloride ion by oxidizing chloride to chlorine.
